(19) United States
(12) Patent Application Publication
(10) Pub. No.: US 2024/0032571 A1
(43) Pub. Date: Feb. 1, 2024

(54) ULTRA-HIGH PROTEIN SOY FLOUR AND METHODS OF MAKING

(71) Applicant: Amfora Inc., San Francisco, CA (US)

(72) Inventors: Lloyd Masato KUNIMOTO, Davis, CA (US); Michael LASSNER, The Dalles, OR (US)

(73) Assignee: Amfora Inc., San Francisco, CA (US)

(21) Appl. No.: 18/355,378

(22) Filed: Jul. 19, 2023

Related U.S. Application Data
(60) Provisional application No. 63/369,929, filed on Jul. 29, 2022.

(51) Int. Cl. A23L 11/00; A23L 33/185; A23J 3/16; A23L 11/30

(52) U.S. Cl. CPC A23L 11/07; A23L 33/185; A23J 3/16; A23L 11/30

(57) ABSTRACT

Provided herein are compositions and methods of producing ultra-high protein (UHP) soy flour and texturized UHP soy flour. The UHP soy flour can be made from soybeans that have a greater protein than the protein content in a corresponding commodity soybean. The UHP soy flour can be expeller pressed UHP soy flour that contains greater than 56 wt. % protein, 1-15 wt. % fat, 1-10 wt. % fiber, and 1-20 wt. % sugar on a dry matter basis. The UHP soy flour can alternatively be a solvent extracted UHP soy flour that contains greater than 60 wt. % protein, 0.1-5 wt. % fat, 1-10 wt. % fiber, and 1-20 wt. % sugar on a dry matter basis. The expeller pressed or solvent extracted UHP soy flours can be used to produce a texturized UHP soy flour that contains greater than 56 wt. % protein, 0.5-3 wt. % fat, and 2-6 wt. % fiber on a dry matter basis.

### CROSS-REFERENCE TO RELATED APPLICATIONS

This application claims the benefit of U.S. Provisional Application No. 63/369,929, filed Jul. 29, 2022, the entire contents of which are hereby incorporated by reference.

### FIELD

The present invention relates to soy flour, and more particularly to ultra-high protein soy flour for use in food products.

### BACKGROUND

Soybeans can be utilized in a broad range of applications from animal nutrition and human nutrition to industrial and consumer products. In the category of human nutrition, soybeans provide essential amino acids and nutrients as well as an excellent source of vegetable protein. Soybeans can provide supplemental protein in foods like soy milk, plant-based meat alternatives, protein bars, baked goods, and meat products, among others. Soybean flour (or soy flour), which can be made from ground soybeans, is particularly useful because soy flour is an economical source of edible protein and thus is a relatively inexpensive means to increase the protein content of food products. Texturized soy flour (also known as texturized soybean protein (TSP) or texturized vegetable protein (TVP)) can be made from soy flour processed in an extruder, and exhibits a laminar structure and elastic and chewy texture similar to that of meat.

Recently, there has been a large push towards fortifying the protein content of foods. Fortifying protein in foods can impact satiety and weight management, aid with building muscle mass and overall strength, as well as aid with maintaining muscle mass for aging individuals. Because soy flour is high in protein, soy flour is particularly well suited to fortifying protein content of foods. Incorporating soy flour into food products also introduces other benefits. For instance, soy flour can increase the shelf life of food products, reduce the amount of added sodium and sugar without affecting taste, improve the texture of gluten-free foods and plant-based foods, reduce the fat content, and reduce or entirely replace costly ingredients in formulations, and so on.

Currently, soy flour is used in various forms in a variety of food products. Soy flour can be used as a thickening agent in sauces, added to baked goods such as doughnuts or bread, used as a meat extender in meat products such as sausages or meatballs, used to make plant-based products such as soymilk, or tofu, etc. Texturized soy flour can be used to replace ground meat in recipes, such as for burgers, pasta sauces, tacos, etc.

The protein content of soy flour products that are currently available varies based on the type of flour. Full-fat soy flour, for instance, generally contains less than 40% protein by weight, while low-fat and defatted soy flour generally contain less than 50% protein by weight. Soy protein concentrate, which is soybean meal after removing the soluble non-protein constituents, generally contains around 70% protein by weight. However, soy protein concentrate is more expensive than soy flour, meaning soy protein concentrate is not an economical choice relative to soy flour in many instances. As increasing protein is a prime driver for incorporating soy flour into the above products, there is an incentive to produce soy flour with high protein content that is more economical than relying on soy protein concentrates.

### SUMMARY

Provided herein are compositions and methods of producing ultra-high protein (UHP) soy flour and texturized UHP soy flour. The UHP soy flour can be made from soybeans that have a protein content that is greater than the protein content in a corresponding commodity soybean. The UHP soy flour can be produced via pressing the UHP soybeans in an expeller to produce an expeller pressed UHP soy flour that contains greater than 56 wt. % protein, 1-15 wt. % fat, 1-10 wt. % fiber, and 1-20 wt. % sugar on a dry matter basis. The UHP soy flour can alternatively be produced via a solvent extraction method that produces a solvent extracted UHP soy flour that contains greater than 60 wt. % protein, 0.1-5 wt. % fat, 1-10 wt. % fiber, and 1-20 wt. % sugar on a dry matter basis. The expeller pressed or solvent extracted UHP soy flours can be used to produce a texturized UHP soy flour that contains greater than 56 wt. % protein, 0.5-3 wt. % fat, and 2-6 wt. % fiber on a dry matter basis. In one or more examples, the UHP soy flours or texturized UHP soy flour can be used in a variety of food products to increase the protein of those food products without relying on expensive soy protein concentrates.

In one or more examples, a soy flour comprises: greater than 56 wt. % protein, 1-15 wt. % fat, 1-10 wt. % fiber, and 1-20 wt. % sugar on a dry matter basis.

Optionally, the soy flour is made from ultra-high protein (UHP) soybeans that have a protein content that is greater than the protein content in a corresponding commodity soybean.

Optionally, the soy flour is made from UHP soybeans that comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the soy flour is made from UHP soybeans that comprise a nucleotide sequence encoding a NF-YC4 (nuclear factor Y subunit C4) that is overexpressed compared to the corresponding commodity soybean which does not overexpress the NF-YC4 protein.

Optionally, the soy flour is expeller pressed soy flour.

Optionally, the soy flour comprises less than 10 wt. % fat.

Optionally, the soy flour comprises less than 10 wt. % salt.

Optionally, the soy flour has a median particle size of less than 150 microns.

Optionally, the soy flour comprises 56-70 wt. % protein.

Optionally, the soy flour comprises 56-65 wt. % protein.

Optionally, the soy flour comprises 4-10 wt. % fat.

Optionally, the soy flour comprises 3-6 wt. % fiber.

Optionally, the soy flour comprises 4-14 wt. % sugar.

In one or more examples, a food product comprises the soy flour.

In one or more examples, a method of manufacturing soy flour from UHP soybeans comprises: pressing UHP soybeans via a screw press, wherein the UHP soybeans have a protein content that is greater than the protein content in a corresponding commodity soybean, and grinding the pressed UHP soybeans into a flour so that not more than 3 wt. % of the ground flour is retained by a 70-mesh screen.

Optionally, the UHP soybeans comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the UHP soybeans comprise a nucleotide sequence encoding a NF-YC4 (nuclear factor Y subunit C4) that is overexpressed compared to the corresponding commodity soybean which does not overexpress the NF-YC4 protein.

Optionally, the method further comprises preparing the UHP soybeans to be pressed, wherein preparing the UHP soybeans to be pressed comprises one or more of cleaning the UHP soybeans, dehulling the UHP soybeans, flaking the UHP soybeans, cooking the UHP soybeans, and drying the UHP soybeans.

Optionally, the manufacturing the soy flour does not increase the salt concentration of the soy flour.

Optionally, the method further comprises drying the UHP soybeans prior to pressing.

Optionally, drying the UHP soybeans comprises drying the soybeans to a moisture content below 10 wt. %.

Optionally, the UHP soybeans are dried via one of a vertical gas or an oil fired forced circulation drier.

Optionally, the method further comprises: after drying the UHP soybeans, tempering the UHP soybeans for 2-5 days to allow moisture equilibrium by diffusion.

Optionally, the method further comprises: cleaning the UHP soybeans prior to pressing.

Optionally, cleaning the UHP soybeans comprises conveying the UHP soybeans over a two-deck vibrating screen such that large debris are captured by a first screen and the soybeans are captured by a second screen, with finer debris particles permitted to pass through both the first screen and the second screen.

Optionally, the method further comprises: prior to pressing, separating split UHP soybeans from whole UHP soybeans, with only the whole UHP soybeans utilized for the soy flour.

Optionally, the method further comprises: prior to pressing, flaking the UHP soybeans, wherein flaking the UHP soybeans comprises feeding the UHP soybeans between a pair of counter-rotating rolls such that the UHP soybeans are flattened as the rolls rotate against one another.

Optionally, the pressed UHP soybeans are ground via one of a hammer mill, a pin mill, and an impact turbo mill.

Optionally, the soy flour has a median particle size of less than 150 microns.

Optionally, the soy flour comprises greater than 56 wt. % protein, 1-15 wt. % fat, 1-10 wt. % fiber, and 1-20 wt. % sugar on a dry matter basis.

Optionally, the soy flour comprises 56-70 wt. % protein.

Optionally, the soy flour comprises 56-65 wt. % protein.

Optionally, the soy flour comprises 4-10 wt. % fat.

Optionally, the soy flour comprises 3-6 wt. % fiber.

Optionally, the soy flour comprises 4-14 wt. % sugar.

In one or more examples, a soy flour comprises: greater than 60 wt. % protein, 0.1-5 wt. % fat, 1-10 wt. % fiber, and 1-20 wt. % sugar on a dry matter basis.

Optionally, the soy flour is made from UHP soybeans that have a protein content that is greater than the protein content in a corresponding commodity soybean.

Optionally, the soy flour is made from UHP soybeans that comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the soy flour is made from UHP soybeans that comprise a nucleotide sequence encoding a NF-YC4 (nuclear factor Y subunit C4) that is overexpressed compared to the corresponding commodity soybean which does not overexpress the NF-YC4 protein.

Optionally, the soy flour is hexane extracted soy flour.

Optionally, the soy flour comprises less than 2 wt. % fat.

Optionally, the soy flour comprises less than 10 wt. % salt.

Optionally, the soy flour has a median particle size of less than 150 microns.

Optionally, the soy flour comprises 60-70 wt. % protein.

Optionally, the soy flour comprises 65-70 wt. % protein.

Optionally, the soy flour comprises 0.5-2 wt. % fat.

Optionally, the soy flour comprises 3-6 wt. % fiber.

Optionally, the soy flour comprises 4-14 wt. % sugar.

Optionally, the sour flour comprises active enzymes.

Optionally, a food product comprises the soy flour.

In one or more examples, a method of manufacturing soy flour from solvent extracted UHP soybeans comprises: preparing a soybean meal from UHP soybeans that have a protein content that is greater than the protein content in a corresponding commodity soybean, diffusing a solvent into the soybean meal, desolventizing the soybean meal, and grinding the desolventized soybean meal into a flour so that not more than 3 wt. % of the ground flour is retained by a 70-mesh screen.

Optionally, the UHP soybeans comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the UHP soybeans comprise a nucleotide sequence encoding a NF-YC4 (nuclear factor Y subunit C4) that is overexpressed compared to the corresponding commodity soybean which does not overexpress the NF-YC4 protein.

Optionally, preparing the soybean meal comprises one or more of drying the soybeans, tempering the soybeans, cleaning the soybeans, sorting the soybeans, cracking the soybeans, dehulling the soybeans, conditioning the soybeans, and flaking the soybeans.

Optionally, the solvent is hexane.

Optionally, diffusing the solvent into the soybean meal is performed via percolation of the solvent over the prepared soybean meal or by flooding the soybean meal with the solvent.

Optionally, desolventizing the soybean meal comprises treating the soybean meal with a heat treatment from a desolventizer-toaster, wherein the heat treatment comprises steaming the soybean meal and allowing the steam to distill to remove the solvent.

Optionally, desolventizing the soybean meal comprises flash desolventizing the soybean meal.

Optionally, flash desolventizing the soybean meal comprises fluidizing the soybean meal in a stream of superheated solvent vapor such that the solvent evaporates from the soybean meal.

Optionally, preparing the soybean meal comprises drying the soybeans to a moisture content below 10 wt. %.

Optionally, the soybeans are dried via one of a vertical gas and an oil fired forced circulation drier.

Optionally, the method comprises: after drying the UHP soybeans, tempering the UHP soybeans for 2-5 days to allow moisture equilibrium by diffusion.

Optionally, preparing the soybean meal comprises cleaning the UHP soybeans via conveying the UHP soybeans over a two-deck vibrating screen such that large debris are captured by a first screen and the UHP soybeans are captured by a second screen, with finer debris particles permitted to pass through both the first screen and the second screen.

Optionally, preparing the soybean meal comprises separating split UHP soybeans from whole UHP soybeans, with only the whole UHP soybeans utilized for the soy flour.

Optionally, preparing the soybean meal comprises flaking the UHP soybeans, which comprises feeding the UHP soybeans between a pair of counter-rotating rolls such that the UHP soybeans are flattened as the rolls rotate against one another.

Optionally, the grinding is via one of a hammer mill, a pin mill, or an impact turbo mill.

Optionally, the soy flour comprises greater than 60 wt. % protein, 0.1-5 wt. % fat, 1-10 wt. % fiber; and 1-20 wt. % sugar on a dry matter basis.

Optionally, manufacturing the soy flour does not increase the salt concentration of the soy flour.

Optionally, the soy flour has a median particle size of less than 150 microns.

Optionally, the soy flour comprises 60-70 wt. % protein.

Optionally, the soy flour comprises 65-70 wt. % protein.

Optionally, the soy flour comprises 0.5-2 wt. % fat.

Optionally, the soy flour comprises 3-6 wt. % fiber.

Optionally, the soy flour comprises 4-14 wt. % sugar.

Optionally, the soy flour comprises active enzymes.

In one or more examples, a texturized soy flour comprises: greater than 56 wt. % protein, 0.5-3 wt. % fat, and 2-6 wt. % fiber a dry matter basis.

Optionally, the texturized soy flour is made from UHP soybeans that have a protein content that is greater than the protein content in a corresponding commodity soybean.

Optionally, the texturized soy flour is made from UHP soybeans that comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the texturized soy flour is made from UHP soybeans that comprise a nucleotide sequence encoding a NF-YC4 (nuclear factor Y subunit C4) that is overexpressed compared to the corresponding commodity soybean which does not overexpress the NF-YC4 protein.

Optionally, the texturized soy flour is texturized expeller pressed soy flour and/or texturized hexane extracted soy flour.

Optionally, a food product comprises the texturized soy flour.

In one or more examples, a method of manufacturing texturized soy flour comprises: preparing soy flour from UHP soybeans that have a protein content that is greater than the protein content in a corresponding commodity soybean, conditioning the soy flour with steam comprising a moisture level between 20-25%, feeding the conditioned soy flour into an extruder and heating the conditioned soy flour to a temperature between 150-180° C., extruding the heated, conditioned soy flour as extrudate via an extruder, and drying the extrudate to obtain texturized soy flour.

Optionally, the UHP soybeans comprise and express a non-native Qua-Quine Starch (QQS) protein that has at least 90% identity to SEQ ID NO: 2 and in which at least the protein content is higher than the protein content in the corresponding commodity soybean which does not express the QQS protein.

Optionally, the UHP soybeans comprise a nucleotide sequence encoding a NF-YC4 (nuclear factor Y subunit C4) that is overexpressed compared to the corresponding commodity soybean which does not overexpress the NF-YC4 protein.

Optionally, the extrudate is cooled before exiting the extruder.

Optionally, preparing the soy flour comprises pressing the UHP soybeans via a screw press; and grinding the pressed UHP soybeans into a flour so that not more than 3% of the ground flour is retained by a 70-mesh screen.

Optionally, the method further comprises preparing the UHP soybeans to be pressed, wherein preparing the UHP soybeans to be pressed comprises one or more of cleaning the UHP soybeans, dehulling the UHP soybeans, flaking the UHP soybeans, cooking the UHP soybeans, and drying the UHP soybeans.

Optionally, the screw press is configured such that the UHP soybeans are increasingly compressed and release oil as they move through the screw press;

Optionally, the method further comprises drying the UHP soy beans prior to pressing.

Optionally, drying the UHP soybeans comprises drying the UHP soybeans to a moisture content below 10%.

Optionally, the UHP soybeans are dried via one of a vertical gas or an oil fired forced circulation drier.

Optionally, the method further comprises: after drying the UHP soybeans, tempering the UHP soybeans for 2-5 days to allow moisture equilibrium by diffusion.

Optionally, the method further comprises cleaning the UHP soybeans prior to pressing.

Optionally, cleaning the UHP soybeans comprises conveying the UHP soybeans over a two-deck vibrating screen such that large debris are captured by a first screen and the soybeans are captured by a second screen, with finer debris particles permitted to pass through both the first screen and the second screen.

Optionally, the method further comprises: prior to pressing, separating split UHP soybeans from whole UHP soybeans, with only the whole soybeans utilized for the soy flour.

Optionally, the method further comprises: prior to pressing, flaking the UHP soybeans, wherein flaking the UHP soybeans comprises feeding the UHP soybeans between a pair of counter-rotating rolls such that the UHP soybeans are flattened as the rolls rotate against one another.

Optionally, the pressed UHP soybeans are ground via one of a hammer mill, a pin mill, and an impact turbo mill.

Optionally, the soy flour has a median particle size of less than 150 microns.

Optionally, the soy flour comprises greater than 56 wt. % protein, 1-15 wt. % fat, 1-10 wt. % fiber, and 1-20 wt. % sugar on a dry matter basis.

Optionally, preparing soy flour from UHP soybeans comprises preparing a soybean meal via UHP soybeans; diffusing a solvent into the soybean meal; desolventizing the soybean meal; and grinding the desolventized soybean meal into a flour so that not more than 3% of the flour is retained by a 70-mesh screen.

Optionally, preparing the soybean meal comprises one or more of drying the UHP soybeans, tempering the UHP soybeans, cleaning the UHP soybeans, sorting the UHP soybeans, cracking the UHP soybeans, dehulling the UHP soybeans, conditioning the UHP soybeans, and flaking the UHP soybeans.

Optionally, the solvent is hexane.

Optionally, diffusing the solvent into the soybean meal is performed via percolation of the solvent over the prepared soybean meal or by flooding the soybean meal with the solvent.

Optionally, desolventizing the soybean meal comprises treating the soybean meal with a heat treatment from a desolventizer-toaster, wherein the heat treatment comprises steaming the soybean meal and allowing the steam to distill to remove the solvent.

Optionally, desolventizing the soybean meal comprises flash desolventizing the soybean meal.

Optionally, flash desolventizing the soybean meal comprises fluidizing the soybean meal in a stream of superheated solvent vapor such that the solvent evaporates from the soybean meal.

Optionally, preparing the soybean meal comprises drying the UHP soybeans to a moisture content below 10%.

Optionally, the UHP soybeans are dried via one of a vertical gas and an oil fired forced circulation drier.

Optionally, the method comprises: after drying the UHP soybeans, tempering the UHP soybeans for 2-5 days to allow moisture equilibrium by diffusion.

Optionally, preparing the soybean meal comprises cleaning the UHP soybeans via conveying the UHP soybeans over a two-deck vibrating screen such that large debris are captured by a first screen and the soybeans are captured by a second screen, with finer debris particles permitted to pass through both the first screen and the second screen.

Optionally, preparing the soybean meal comprises separating split UHP soybeans from whole UHP soybeans, with only the whole soybeans utilized for the soy flour.

Optionally, preparing the soybean meal comprises flaking the UHP soybeans, which comprises feeding the UHP soybeans between a pair of counter-rotating rolls such that the UHP soybeans are flattened as the rolls rotate against one another.

Optionally, the grinding is via one of a hammer mill, a pin mill, or an impact turbo mill.

Optionally, the soy flour comprises greater than 60 wt. % protein, 0.1-5 wt. % fat, 1-10 wt. % fiber; and 1-20 wt. % sugar on a dry matter basis.

Optionally, the texturized soy flour comprises 60-65 wt. % protein; 0.5-3 wt. % fat; and 2-6 wt. % a dry matter basis.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The present invention generally relates to soy flour and a method of producing soy flour and texturized soy flour containing significant levels of protein. Relative to commodity soy flour, the UHP soy flour contains more protein by wt. % and thus can provide more protein to food products.

To produce soy flour with more protein than commodity soy flour, the soy flour disclosed herein can be made from ultra-high protein (UHP) soybeans that have a protein content that is greater than the protein content of commodity soybeans. Generally, commodity soybeans have a protein content up to 40% on a dry matter basis (DMB). The UHP soybeans can include soybeans with a protein content greater than 48% DMB. The UHP soybeans may have been bred such that the protein content of the UHP soybeans is greater than the protein content of the commodity soybeans. The UHP soybeans may have been modified to have a protein content that is greater than the protein content of the commodity soybeans n by one or more processes. For instance, the soy flour can be made from UHP soybeans that have been modified to express Qua-Quine Starch (QQS), as discussed in U.S. Pat. No. 9,850,484 which is hereby incorporated by reference. Soybeans that have been modified to express QQS can have more protein than commodity soybeans, which do not express QQS. Soybeans that express QQS can have at least 30% more protein than commodity soybeans. By expressing the QQS in the soybeans, the amount of protein can be increased by 10%, 15%, or up at 30%.

Optionally, the soy flour disclosed herein can be made from soybeans that have been modified to overexpress the nucleotide sequence encoding a NF-YC4 (nuclear factor Y subunit C4), as discussed in U.S. Pat. No. 10,640,781 which is hereby incorporated by reference. Soybeans that have been modified to overexpress the nucleotide sequence encoding NF-YC4 can have increased total protein content relative to the total protein content in the corresponding commodity soybeans.

The UHP soy flour can be produced by expeller pressing. To produce UHP soy flour via expeller pressing, the UHP soybeans can be dehulled, pressed into a press cake by a screw press, and then ground into a flour. The screw press can be configured such that the soybeans are increasingly compressed and release oil as they move through the screw press to create a press cake. Optionally, the press cake can be ground into a flour so that not more than 3 wt. % of the ground flour is retained by a 70-mesh screen. The press cake can be ground via a conventional grinding process. For instance, the press cake can be ground via one of a hammer mill, a pin mill, and an impact turbo mill. The soy flour can have a median particle size of less than 150 microns.

Optionally, the soybeans can be dried prior to pressing. For instance, the soybeans can be dried to a moisture content below 10 wt. %. Optionally the soybeans can be dried via a vertical gas or an oil fired circulation drier. After drying the soybeans, the soybeans can be tempered. Tempering the soybeans can allow the remaining moisture in the soybeans to reach a moisture equilibrium by diffusion. Optionally, the soybeans can be tempered for 2-5 days.

The soybeans can be prepared via one or more processes prior to pressing. Preparing the soybeans can include one or more of cleaning the soybeans, dehulling the soybeans, flaking the soybeans, cooking the soybeans, and/or drying the soybeans. The soybeans can be cleaned by conveying the soybeans over a two-deck vibrating screen such that large debris are captured by a first screen and the soybeans are captured by a second screen, with finer debris particles permitted to pass through both the first screen and the second screen. The soybeans can be flaked by feeding the soybeans between a pair of counter-rotating rolls such that the soybeans are flattened as the rolls rotate against one another. The soybeans can be cooked by boiling the soybeans in water. The soybeans can be dried as discussed above. Optionally, prior to pressing, the soybeans can be sorted. Sorting the soybeans (also referred to as “classification”) can include sifting the soybeans to separate split beans from whole beans, with only the whole beans being utilized for the soy flour.

The expeller pressed UHP soy flour can contain greater than about 56 wt. % protein, greater than about 60 wt. % protein, greater than about 62 wt. % protein, greater than about 65 wt. % protein, greater than about 68 wt. % protein, or greater than about 70 wt. % protein on a dry matter basis. In some embodiments, the expeller pressed UHP soy flour can contain less than about 90 wt. % protein, less than about 85 wt. % protein, less than about 80 wt. % protein, less than about 75 wt. % protein, less than about 70 wt. % protein, less than about 65 wt. % protein, or less than about 60 wt. % protein on a dry matter basis. In some embodiments, the expeller pressed UHP soy flour contains between about 56-70 wt. % protein, about 56-65 wt. % protein, about 56-63 wt. % protein on a dry matter basis.

The expeller pressed UHP soy flour can contain between about 1-10 wt. % fiber, about 3-6 wt. % fiber, or about 3-5 wt. % fiber on a dry matter basis. In some embodiments, the expeller pressed UHP soy flour can contain greater than about 1 wt. % fiber, greater than about 2 wt. % fiber, greater than about 3 wt. % fiber, or greater than about 4 wt. % fiber on a dry matter basis. In some embodiments, the expeller pressed UHP soy flour can contain less than about 10 wt. % fiber, less than about 8 wt. % fiber, less than about 5 wt. % fiber, or less than about 4 wt. % fiber on a dry matter basis.

The expeller pressed UHP soy flour can contain between about 1-20 wt. % sugar, about 2-18 wt. %, or about 4-13 wt. % on a dry matter basis. In some embodiments, the expeller pressed UHP soy flour can contain greater than about 1 wt. % sugar, greater than about 2 wt. % sugar, greater than about 4 wt. % sugar, greater than about 6 wt. % sugar, greater than about 8 wt. % sugar, or greater than about 10 wt. % sugar on a dry matter basis. In some embodiments, the expeller pressed UHP soy flour can contain less than about 20 wt. % sugar, less than about 18 wt. % sugar, less than about 15 wt. % sugar, less than about 13 wt. % sugar, less than about 10 wt. % sugar, or less than about 8 wt. % sugar on a dry matter basis.

The expeller pressed UHP soy flour can contain less salt or sodium than soy protein concentrate and soy protein isolates. For instance, the expeller pressed UHP soy flour can contain less than 10 wt. %, less than 8 wt. %, less than 5 wt. %, less than 4 wt. %, less than 2 wt. %, or less than 1 wt. % salt or sodium on a dry matter basis. In some embodiments, the expeller pressed UHP soy flour can contain greater than 0.1 wt. % salt or sodium on a dry matter basis. Soy protein concentrates and soy protein isolates, which undergo a concentration process to increase the percentage of protein, generally contain a high percentage of salt due to the concentration process. In contrast, the expeller pressed UHP soy flour disclosed herein may not undergo a concentration process because the expeller pressed UHP soy flour already contains a high percentage of protein. Beneficially, by avoiding the concentration process, the expeller pressed UHP soy flour disclosed herein can contain less salt than soy protein concentrate and soy protein isolates. Avoiding the concentration process can also ensure that the expeller pressed UHP soy flour is more economical than soy protein concentrate and soy protein isolates.

The expeller pressed UHP soy flour can contain between about 1-15 wt. % fat, about 4-10 wt. % fat, or about 6-8 wt. % fat on a dry matter basis. In some embodiments, the expeller pressed UHP soy flour can have greater than about 1 wt. % fat, greater than about 3 wt. % fat, or greater than about 6 wt. % fat on a dry matter basis. In some embodiments, the expeller pressed UHP soy flour can have less than 15 wt. % fat, less than about 12 wt. % fat, less than about 10 wt. % fat, or less than about 8 wt. % fat.

The expeller pressed UHP soy flour can be similar to commodity low fat soy flour, except the expeller pressed UHP soy flour can contain more protein than the commodity low fat soy flour.

In some embodiments, the expeller pressed UHP soy flour can contain greater than 56 wt. % protein, between 1-15 wt. % fat, between 1-10 wt. % fiber, and between 1-20 wt. % sugar, on a dry matter basis. The expeller pressed UHP soy flour can be used in a variety of food products. For instance, the expeller pressed UHP soy flour can be incorporated into baked goods, meat products, alternative meat products, sauces, snack foods, etc. When incorporated into food products, the expeller pressed UHP soy flour can increase the protein content of the food products, as well as provide other benefits such as increased shelf life, improved crumb of baked goods, decreased fat absorption of fried foods, decreasing cost by displacing other more expensive ingredients, etc.

Example nutritional information for expeller pressed UHP soy flour is provided below in Table 1.

TABLE 1
Expeller Pressed UHP Soy Flour Nutritional Information

| | Batch A | Batch B |
|---|---|---|
| Wt. % Moisture | 6.78 | 6.10 |
| Wt. % Fat (DMB) | 5.56 | 8.07 |
| Wt. % Fiber (DMB) | 2.90 | 3.51 |
| Wt. % Protein (DMB) | 62.82 | 60.11 |

Alternatively, the UHP soy flour can be produced by a solvent extraction method. Producing the UHP soy flour by solvent extraction, can include dehulling the UHP soybeans, preparing a soybean meal from the dehulled UHP soybeans, diffusing a solvent into the soybean meal, desolventizing the soybean meal (i.e., extracting the solvent), and/or then grinding the desolventized soybean meal into a flour. The soybeans can be modified by one of the methods discussed above and/or bred such that they have a protein content that is greater than the protein content in a corresponding commodity soybean.

Preparing a soybean meal can include one or more of drying the soybeans, tempering the soybeans, cleaning the soybeans, dehulling the soybeans, sorting the soybeans, cracking the soybeans, conditioning the soybeans, and flaking the soybeans. The soybeans can be dried via a vertical gas or an oil fired circulation drier. Optionally, the soybeans are dried to a moisture content below 10 wt. %. After drying the soybeans, the soybeans can be tempered. Tempering the soybeans can allow the remaining moisture in the soybeans to reach a moisture equilibrium by diffusion. Optionally, the soybeans can be tempered for 2-5 days. The soybeans can be cleaned as discussed above, such as by conveying the soybeans over a two-deck vibrating screen such that large debris are captured by a first screen and the soybeans are captured by a second screen, with finer debris particles permitted to pass through both the first screen and the second screen. Sorting the soybeans (also referred to as “classification”) can include sifting the soybeans to separate split beans from whole beans, with only the whole beans being utilized for the soy flour.

Prior to flaking, the soybeans can be cracked and conditioned. Cracking the soybeans can include breaking the soybeans into smaller particles in preparation for flaking. The soybeans can be cracked by feeding the soybeans between a pair of counter-rotating corrugated rolls, with one of the rolls rotating faster than the other to provide a shearing effect that breaks the soybeans. Conditioning the soybeans can include heating the soybean meats to between 65-70° C. to increase the plasticity of the meats so they can be flattened by pressure without breaking in the flaker. The soybeans can be flaked by feeding the soybeans between a pair of counter-rotating rolls such that the soybeans are flattened as the rolls rotate against one another.

Diffusing a solvent into the soybean meal can include percolating a solvent over the soybean meal. Percolating the solvent over the soybean meal can include allow the solvent to trickle through the soybean meal, and more preferably, through the flaked prepared soybeans without entirely submerging the soybean meal. This can allow the solvent to flow rapidly over the surface of the soybean meal to efficiently remove the oil that has diffused to the surface of the soybean meal. Alternatively, diffusing the solvent into the soybean meal can include flooding the soybean meal by totally immersing the soybean meal in a slowly moving, continuous phase of solvent. In some embodiments, the solvent is hexane.

Desolventizing the soybean meal can include treating the solvent laden soybean meal with a heat treatment from a desolventizer-toaster. The desolventizer-toaster can steam the soybean meal and thereby encourage the steam to distill and remove the solvent from the soybean meal. Desolventizing the soybean meal can alternatively include flash desolventizing. Flash desolventizing the soybean meal can include fluidizing the solvent laden soybean meal in a stream of superheated solvent vapors, which encourages the solvent to evaporate from the soybean meal. Soybean meal that has been flash desolventized can also undergo rapid cooling, and a short stripping stage to ensure the solvent has been completely removed.

The desolventized soybean meal can be ground into a flour so that not more than 3 wt. % of the ground flour is retained by a 70-mesh screen. The desolventized soybean meal can be ground via a conventional grinding process. For instance, the desolventized soybean meal can be ground via one of a hammer mill, a pin mill, and an impact turbo mill. The soy flour can have a median particle size of less than 150 microns.

The solvent extracted UHP soy flour can contain greater than about 56 wt. % protein, greater than about 60 wt. % protein, greater than about 62 wt. % protein, greater than about 65 wt. % protein, greater than about 68 wt. % protein, or greater than about 70 wt. % protein on a dry matter basis. In some embodiments, the solvent extracted UHP soy flour can contain less than about 90 wt. % protein, less than about 85 wt. % protein, less than about 80 wt. % protein, less than about 75 wt. % protein, less than about 70 wt. % protein, less than about 65 wt. % protein, or less than about 60 wt. % protein on a dry matter basis. In some embodiments, the solvent extracted UHP soy flour contains between about 56-70 wt. % protein, about 60-70 wt. % protein, about 60-67 wt. % protein on a dry matter basis.

The solvent extracted UHP soy flour can contain between about 1-10 wt. % fiber, about 3-6 wt. % fiber, or about 3-5 wt. % fiber on a dry matter basis. In some embodiments, the solvent extracted UHP soy flour can contain greater than about 1 wt. % fiber, greater than about 2 wt. % fiber, greater than about 3 wt. % fiber, or greater than about 4 wt. % fiber on a dry matter basis. In some embodiments, the solvent extracted UHP soy flour can contain less than about 10 wt. % fiber, less than about 8 wt. % fiber, less than about 5 wt. % fiber, or less than about 4 wt. % fiber on a dry matter basis.

The solvent extracted UHP soy flour can contain between about 1-20 wt. % sugar, about 2-18 wt. %, or about 5-14 wt. % on a dry matter basis. In some embodiments, the solvent extracted UHP soy flour can contain greater than about 1 wt. % sugar, greater than about 2 wt. % sugar, greater than about 4 wt. % sugar, greater than about 6 wt. % sugar, greater than about 8 wt. % sugar, or greater than about 10 wt. % sugar on a dry matter basis. In some embodiments, the solvent extracted UHP soy flour can contain less than about 20 wt. % sugar, less than about 18 wt. % sugar, less than about 15 wt. % sugar, less than about 13 wt. % sugar, less than about 10 wt. % sugar, or less than about 8 wt. % sugar on a dry matter basis.

The solvent extracted UHP soy flour can contain less salt or sodium than soy protein concentrate and soy protein isolates. For instance, the solvent extracted UHP soy flour can contain less than 10 wt. %, less than 8 wt. %, less than 5 wt. %, less than 4 wt. %, less than 2 wt. %, or less than 1 wt. % salt or sodium on a dry matter basis. In some embodiments, the solvent extracted UHP soy flour can contain greater than 0.1 wt. % salt or sodium on a dry matter basis. Soy protein concentrates and soy protein isolates, which undergo a concentration process to increase the percentage of protein, generally contain a high percentage of salt due to the concentration process. In contrast, the solvent extracted UHP soy flour disclosed herein may not undergo a concentration process because the solvent extracted UHP soy flour already contains a high percentage of protein. Beneficially, by avoiding the concentration process, the solvent extracted UHP soy flour disclosed herein can contain less salt than soy protein concentrate and soy protein isolates. Avoiding the concentration process can also ensure that the solvent extracted UHP soy flour is more economical than soy protein concentrate and soy protein isolates.

The solvent extracted UHP soy flour can contain between about 0.1-5 wt. % fat, about 0.5-3 wt. % fat, or about 0.5-2 wt. % fat on a dry matter basis. In some embodiments, the solvent extracted UHP soy flour can have greater than about 0.1 wt. % fat, greater than about 0.5 wt. % fat, or greater than about 1 wt. % fat on a dry matter basis. In some embodiments, the solvent extracted UHP flour can have less than 5 wt. % fat, less than about 3 wt. % fat, less than about 2 wt. % fat, or less than about 1.5 wt. % fat.

The solvent extracted UHP soy flour can contain active enzymes. Soy flour with enzymes (also called “enzyme-active”) may be necessary for white breads, as the lipoxygenase enzyme can catalyze oxidative bleaching of carotenoid pigments in wheat flour, which has a significant impact on crumb whitening during the mixing and proofing stages of bread manufacture. Generally, enzyme active soy flour is soy flour prepared without heat treatment, which does not include expeller pressed soy flour. The solvent extracted UHP soy flour that is flash desolventized can result in active enzyme soy flour.

The solvent extracted UHP soy flour can contain greater than 60 wt. % protein, between 0.1-5 wt. % fat, between 1-10 wt. % fiber, and between 1-20 wt. % sugar, on a dry matter basis. The solvent extracted UHP soy flour can be used in a variety of food products. For instance, the solvent extracted UHP soy flour can be incorporated into baked goods, meat products, alternative meat products, sauces, snack foods, etc. When incorporated into food products, the solvent extracted UHP soy flour can increase the protein content of the food products, as well as provide other benefits such as increased shelf life, improved crumb of baked goods, decreased fat absorption of fried foods, decreasing cost by displacing other more expensive ingredients, etc.

Example nutritional information for solvent extracted UHP soy flour is provided below in Table 2.

TABLE 2
Solvent Extracted UHP Soy Flour Nutritional Information

| | Batch A | Batch B | Batch C | Batch D |
|---|---|---|---|---|
| Wt. % Moisture | 6.76 | 7.28 | 6.92 | 4.27 |
| Wt. % Fat (DMB) | 0.89 | 0.79 | 1.58 | 0.49 |
| Wt. % Fiber (DMB) | 3.54 | 3.77 | 4.62 | 3.97 |
| Wt. % Protein (DMB) | 63.37 | 63.07 | 60.76 | 62.09 |

UHP soy flour that is produced by either expeller pressing or solvent extraction as discussed above can be used to produce texturized UHP soy flour. Producing texturized UHP soy flour can involve preparing UHP soy flour, conditioning the UHP soy flour with steam comprising a moisture level between 20-25%, feeding the conditioned soy flour into an extruder and heating the conditioned soy flour to a temperature between 150-180° C., extruding the heated, conditioned soy flour as an extrudate via the extruder, and drying the extrudate to obtain texturized soy flour. Optionally, the extrudate can be cooled before exiting the extruder. The texturized UHP soy flour can be produced from soy flour made using soybeans that have been modified and/or bred to have a protein content that is greater than the protein content in a corresponding commodity soybean.

The texturized UHP soy flour can contain greater than about 56 wt. % protein, greater than about 60 wt. % protein, greater than about 61 wt. % protein, or greater than or equal to about 62 wt. % protein on a dry matter basis. In some embodiments, the texturized UHP soy flour can contain less than about 90 wt. % protein, less than about 85 wt. % protein, less than about 80 wt. % protein, less than about 75 wt. % protein, less than about 70 wt. % protein, less than about 65 wt. % protein, or less than about 60 wt. % protein on a dry matter basis. In some embodiments, the texturized UHP soy flour contains between about 56-70 wt. % protein, about 60-70 wt. % protein, about 60-65 wt. % protein on a dry matter basis.

The texturized UHP soy flour can contain between about 1-10 wt. % fiber, about 3-6 wt. % fiber, or about 3-5 wt. % fiber on a dry matter basis. In some embodiments, the texturized UHP soy flour can contain greater than about 1 wt. % fiber, greater than about 2 wt. % fiber, greater than about 3 wt. % fiber, or greater than about 4 wt. % fiber on a dry matter basis. In some embodiments, the texturized UHP soy flour can contain less than about 10 wt. % fiber, less than about 8 wt. % fiber, less than about 5 wt. % fiber, or less than about 4 wt. % fiber on a dry matter basis.

The texturized UHP soy flour can contain between about 0.1-5 wt. % fat, about 0.5-3 wt. % fat, about 0.5-2 wt. % fat, or about 1-2 wt. % fat on a dry matter basis. In some embodiments, the texturized UHP soy flour can have greater than about 0.1 wt. % fat, greater than about 0.5 wt. % fat, or greater than about 1 wt. % fat on a dry matter basis. In some embodiments, the texturized UHP soy flour can have less than 5 wt. % fat, less than about 3 wt. % fat, less than about 2 wt. % fat, or less than about 1.5 wt. % fat on a dry matter basis.

The texturized UHP soy flour can contain greater than 60 wt. % protein, between 0.5-3 wt. % fat, and between 2-6 wt. % fiber, on a dry matter basis. The texturized UHP soy flour can be used in a variety of food products. For instance, the texturized UHP soy flour can be incorporated into processed meat products such as tacos, pizza toppings, meat sauces, plant-based meat alternatives, bars and snacks, cereals, etc. When incorporated into food products, the texturized UHP soy flour (also called UHP-TVP) can increase the protein content of the food products while requiring less added texturized UHP soy flour, as well as provide other benefits such as increased moisture retention, lower sodium, increased browning, higher cooked yield, etc.

In accordance with the foregoing, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A soy flour comprising:
greater than 56 wt. % protein;
1-15 wt. % fat;
1-10 wt. % fiber; and
1-20 wt. % sugar on a dry matter basis.

2. The soy flour of claim 1, wherein the soy flour is made from ultra-high protein (UHP) soybeans that have a protein content that is greater than the protein content in a corresponding commodity soybean.

3. The soy flour of claim 2, wherein the soy flour is made from UHP soybeans that comprise and express a non-native Qua-Quine Starch (QQS) protein that has at least 90% identity to SEQ ID NO: 2 and in which at least the protein content is higher than the protein content in the corresponding commodity soybean which does not express the QQS protein.

4. The soy flour of claim 2, wherein the soy flour is made from UHP soybeans that comprise a nucleotide sequence encoding a NF-YC4 (nuclear factor Y subunit C4) that is overexpressed compared to the corresponding commodity soybean which does not overexpress the NF-YC4 protein.

5. The soy flour of claim 1, wherein the soy flour is expeller pressed soy flour.

6. The soy flour of claim 5, wherein the soy flour comprises less than 10 wt. % fat.

7. The soy flour of claim 1, wherein the soy flour comprises less than 10 wt. % salt.

8. The soy flour of claim 1, wherein the soy flour has a median particle size of less than 150 microns.

9. The soy flour of claim 1, wherein the soy flour comprises 56-70 wt. % protein.

10. The soy flour of claim 1, wherein the soy flour comprises 56-65 wt. % protein.

11. The soy flour of claim 1, wherein the soy flour comprises 4-10 wt. % fat.

12. The soy flour of claim 1, wherein the soy flour comprises 3-6 wt. % fiber.

13. The soy flour of claim 1, wherein the soy flour comprises 4-14 wt. % sugar.

14. A food product comprising the soy flour of claim 1.

15. A method of manufacturing soy flour from UHP soybeans comprising:
pressing UHP soybeans via a screw press, wherein the UHP soybeans have a protein content that is greater than the protein content in a corresponding commodity soybean; and
grinding the pressed UHP soybeans into a flour so that not more than 3 wt. % of the ground flour is retained by a 70-mesh screen.

16. The method of claim 15, wherein the UHP soybeans comprise and express a non-native Qua-Quine Starch (QQS) protein that has at least 90% identity to SEQ ID NO: 2 and in which at least the protein content is higher than the protein content in the corresponding commodity soybean which does not express the QQS protein.

17. The method of claim 15, wherein the UHP soybeans comprise a nucleotide sequence encoding a NF-YC4 (nuclear factor Y subunit C4) that is overexpressed compared to the corresponding commodity soybean which does not overexpress the NF-YC4 protein.

18. The method of claim 15, further comprising preparing the UHP soybeans to be pressed, wherein preparing the UHP soybeans to be pressed comprises one or more of cleaning the UHP soybeans, dehulling the UHP soybeans, flaking the UHP soybeans, cooking the UHP soybeans, and drying the UHP soybeans.

19. The method of claim 15, wherein manufacturing the soy flour does not increase the salt concentration of the soy flour.

20. The method of claim 15, further comprising drying the UHP soybeans prior to pressing.

21. The method of claim 20, wherein drying the UHP soybeans comprises drying the soybeans to a moisture content below 10 wt. %.

22. The method of claim 20, wherein the UHP soybeans are dried via one of a vertical gas or an oil fired forced circulation drier.

23. The method of claim 20, further comprising: after drying the UHP soybeans, tempering the UHP soybeans for 2-5 days to allow moisture equilibrium by diffusion.

24. The method of claim 15, further comprising cleaning the UHP soybeans prior to pressing.

25. The method of claim 24, wherein cleaning the UHP soybeans comprises conveying the UHP soybeans over a two-deck vibrating screen such that large debris are captured by a first screen and the soybeans are captured by a second screen, with finer debris particles permitted to pass through both the first screen and the second screen.

26. The method of claim 15, further comprising, prior to pressing, separating split UHP soybeans from whole UHP soybeans, with only the whole UHP soybeans utilized for the soy flour.

27. The method of claim 15, further comprising, prior to pressing, flaking the UHP soybeans, wherein flaking the UHP soybeans comprises feeding the UHP soybeans between a pair of counter-rotating rolls such that the UHP soybeans are flattened as the rolls rotate against one another.

28. The method of claim 15, wherein the pressed UHP soybeans are ground via one of a hammer mill, a pin mill, and an impact turbo mill.

29. The method of claim 15, wherein the soy flour has a median particle size of less than 150 microns.

30. The method of claim 15, wherein the soy flour comprises greater than 56 wt. % protein, 1-15 wt. % fat, 1-10 wt. % fiber, and 1-20 wt. % sugar on a dry matter basis.

31. The method of claim 30, wherein the soy flour comprises 56-70 wt. % protein.

32. The method of claim 31, wherein the soy flour comprises 56-65 wt. % protein.

33. The method of claim 30, wherein the soy flour comprises 4-10 wt. % fat.

34. The method of claim 30, wherein the soy flour comprises 3-6 wt. % fiber.

35. The method of claim 30, wherein the soy flour comprises 4-14 wt. % sugar.
